(19) United States
(12) Patent Application Publication
(10) Pub. No.: US 2003/0067756 A1
(43) Pub. Date: Apr. 10, 2003

(54) Electrical service distribution board

(76) Inventors: Heinz Erich Popa, Bammental (DE); Friedhelm Ritter, Oberhaching (DE)

Correspondence Address: LERNER AND GREENBERG, P.A., Post Office Box 2480, Hollywood, FL, 33022-2480, US

(21) Appl. No.: 10/252,289

(22) Filed: Sep. 23, 2002

(30) Foreign Application Priority Data
Sep. 21, 2001 (DE) 101 46 503.3

(51) Int. Cl. H01R 9/00

(52) U.S. Cl. 361/775

(57) ABSTRACT

An electrical service distributions board is described, which is accommodated in a housing, has a feed conductor that is inserted into the housing and has outgoer conductors that lead to individual loads. Electrical service devices such as fault-current circuit breakers, circuit breakers and the like are provided, which can be connected by a plug connection to busbars that are connected to the feed conductor and to the outgoer conductors. A mounting plate for holding the service devices is provided. The busbars are disposed underneath the mounting plate and the mounting plate has openings into which plug elements which are disposed on the service devices can be inserted toward the busbars. The busbars of different phases and feeds and the outgoers are disposed such that they are insulated with respect to one another and from one another in the same planes and are embedded, preferably encapsulated, in an insulating housing.

### BACKGROUND OF THE INVENTION

### Field of the Invention

The invention relates to an electrical service distribution board that is accommodated in a housing and has a feed conductor which is inserted into the housing and outgoer conductors which lead to individual loads. Electrical service devices such as fault-current circuit breakers, circuit breakers and the like are provided. The service devices can be connected by a plug connection to busbars that are connected to the feed conductor and to the outgoer conductors. A mounting plate is provided for holding the service devices, and the busbars are disposed underneath the mounting plate. The mounting plate has openings into which plug elements that are disposed on the service devices can be inserted toward the busbars.

Service distribution boards such as these are installed for electrical power distribution and protection in buildings, circuit breakers, fault current circuit breakers and the like and are accommodated in a service distribution board housing and are intended to protect individual loads within a network. Housings such as these normally contain top-up profile mounting rails at the bottom of the housing, onto which the switching devices are snapped. The switching devices are connected to one another phase-by-phase by busbars, with only one busbar being used for single-phase devices, and so-called busbar blocks being used for polyphase applications, which have a busbar holding housing with a number of chambers, and ribbon conductors inserted into the chambers, with connecting lugs being provided on the ribbon conductors, which can be inserted into connecting terminals on the switching devices, and can be clamped firmly in them. If a number of top-up profile mounting rails are disposed one above the other, then connection conductor configurations are provided, to which the individual busbars are connected.

Published, Non-Prosecuted German Patent Application DE 196 28 957 A1 discloses a service distribution board which has a housing in which ribbon conductors are accommodated, on which connecting lugs are integrally formed which have contact tulips, into which plug lugs which are disposed on the lower face of the switching devices can be inserted, with a top-up profile mounting rail onto which the switching devices are snapped fitted to the housing. When they are snapped on, the plug lugs make an electrically conductive contact with the contact tulips through openings that are provided in the housing. The switching devices that are used are those that have a normal switching device form; the plug lug is just fitted on the lower face instead of screw connecting terminals, into which electrical conductors can be inserted through openings on the narrow faces of the switching devices.

In comparison to conventional distribution boards, the configuration considerably simplifies the mounting process to the extent that, at least on the access side of the switching device, there is no longer any need to firmly clamp an electrical conductor or a connecting lug of a busbar by a tool.

A feed line is inserted into the distribution board and is connected to the busbars. The outgoer lines which are associated with the individual switching devices are laid within the service distribution board housing and are passed out of the housing, with the outgoer lines being connected to the feeders to the loads. In this case, incorrect connections can occur due to confusion, for example with a load that is to be protected by a fault-current circuit breaker incorrectly being connected to a circuit breaker.

### SUMMARY OF THE INVENTION

It is accordingly an object of the invention to provide an electrical service distribution board which overcomes the above-mentioned disadvantages of the prior art devices of this general type, which is even easier to install, and in which incorrect connections are avoided.

With the foregoing and other objects in view there is provided, in accordance with the invention, an electrical service distribution board. The board contains an insulating housing, a feed conductor, outgoer conductors leading to individual loads, and busbars connected to the feed conductor and to the outgoer conductors. The busbars are of different phases and feeds and the outgoer conductors are disposed insulated with respect to one another and from one another in equivalent planes and are embedded in the insulating housing. Electrical service devices being either fault-current circuit breakers or circuit breakers, are connected by a plug connection to the busbars. Plug elements are disposed on the electrical services devices. A mounting plate for holding the electrical service devices is provided. The busbars are disposed underneath the mounting plate. The mounting plate has openings into which the plug elements disposed on the electrical service devices can be inserted toward the busbars.

According to the invention, the busbars of different phases are disposed isolated from one another phase-by-phase in the same planes and are in this case embedded, preferably encapsulated, in an insulating body.

Each busbar may in this case have a connection section, which runs transversely with respect to the direction in which the service devices are disposed in rows, for each phase, and to which a number of tongues corresponding to the number of service device rows are fitted, which run underneath the service devices and which have the holding opening for plug elements on the service devices. The busbar for the neutral conductor likewise has a connection section which runs transversely with respect to the direction in which the service devices are disposed in rows, and to which a number of tongues corresponding to the number of service device rows are fitted, which run underneath the service devices and have the holding openings for the plug elements.

The busbars may in this case be disposed one above the other with the tongues of different phases being offset with respect to one another.

In accordance with an added feature of the invention, the busbars have tongues for different phases and are disposed one above another and the tongues for the different phases are offset with respect to one another.

In accordance with an additional feature of the invention, each of the busbars have tongues and the tongues of a respective busbar lie in a same plane, and the tongues of at least two of the busbars lie in a further plane.

In accordance with another feature of the invention, the tongues of one phase preferably lie in one plane, and the tongues of other phases and of a neutral conductor lie in different planes.

In accordance with a further feature of the invention, two of the busbars are disposed in different planes for single-phase devices, and the two of the busbars are connected by the plug connection, to one phase.

In accordance with a further added feature of the invention, the plug elements have at least one pair of tines formed such that the tines are sprung transversely with respect to an insertion direction.

In accordance with a further additional feature of the invention, the plug elements have two tines offset and sprung transversely with respect to an insertion direction.

In accordance with a concomitant feature of the invention, the busbars and the outgoer conductors are encapsulated in the insulating housing.

Other features which are considered as characteristic for the invention are set forth in the appended claims.

Although the invention is illustrated and described herein as embodied in an electrical service distribution board, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic plan view of individual phase busbars according to the invention;

FIG. 2 is a sectional view through a busbar housing;

FIGS. 3A-3E are sectional views through the busbar housing showing different methods of making contact;

FIG. 4 is a side-elevational view of a contact pin;

FIG. 5 is a front-elevational view of the contact pin;

FIG. 6A is a side-elevational view of a subregion of the busbar configuration;

FIG. 6B is a plan view of the subregion of the busbar configuration;

FIG. 7 is a bottom plan view of a refinement of a service device;

FIG. 8 is a side-elevational view of the service device shown in FIG. 7;

FIG. 9 is a view of a narrow face of the service device shown in FIGS. 7 and 8; and

FIG. 10 is an illustration of a device lock, by which a device can be fixed on a busbar housing.

### DESCRIPTION OF THE PREFERRED EMBODIMENTS

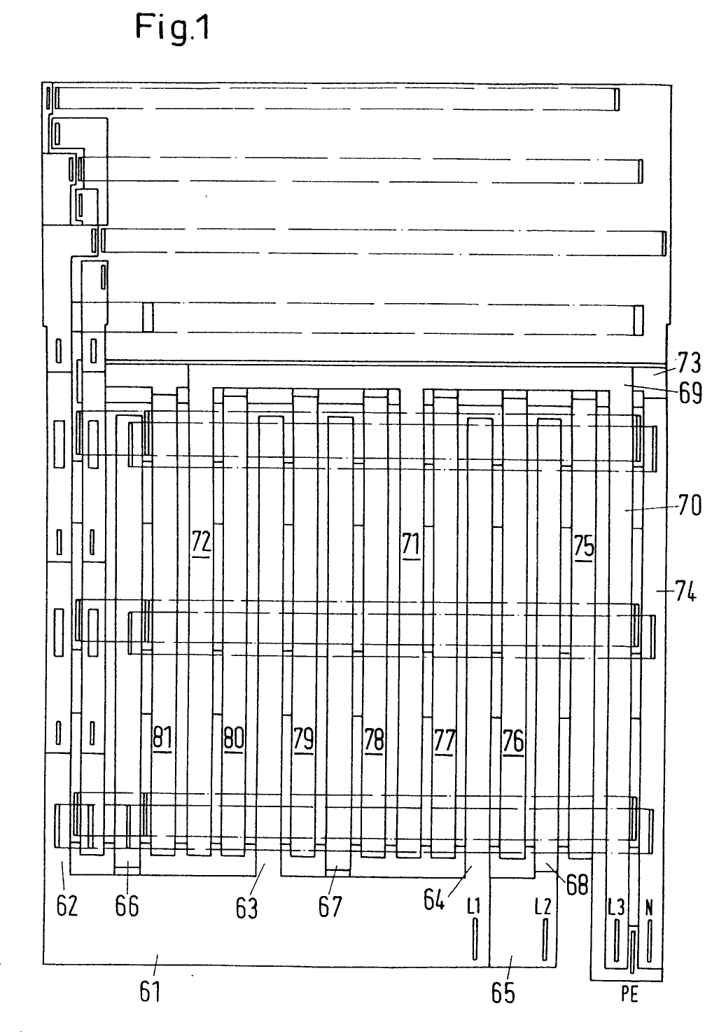

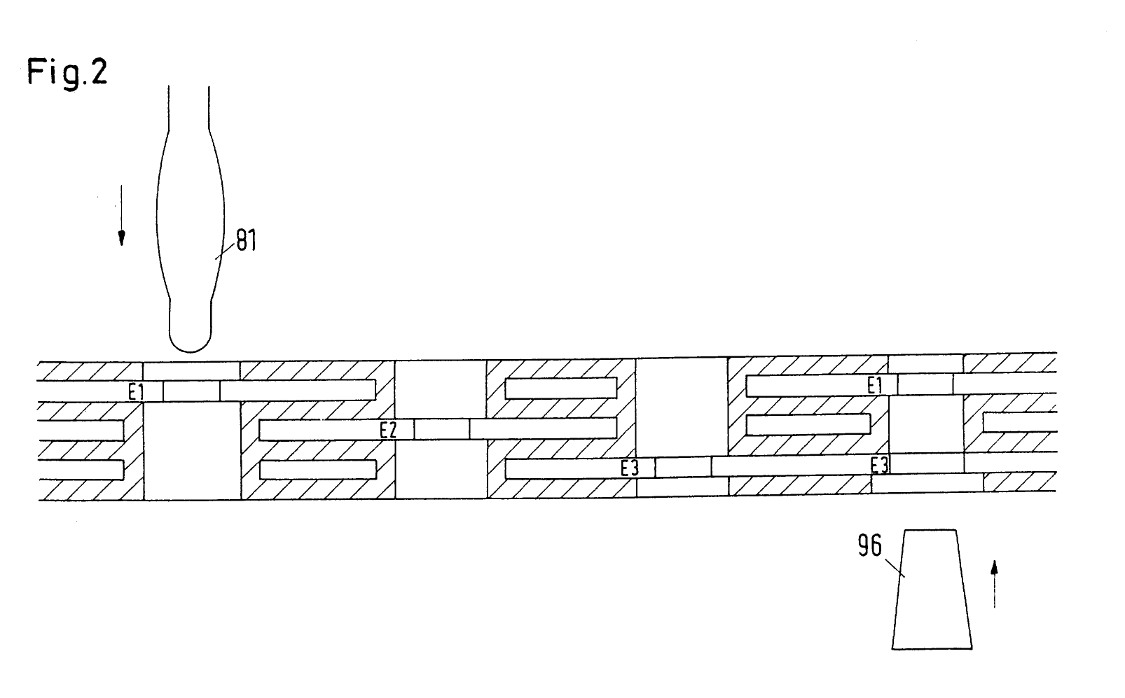

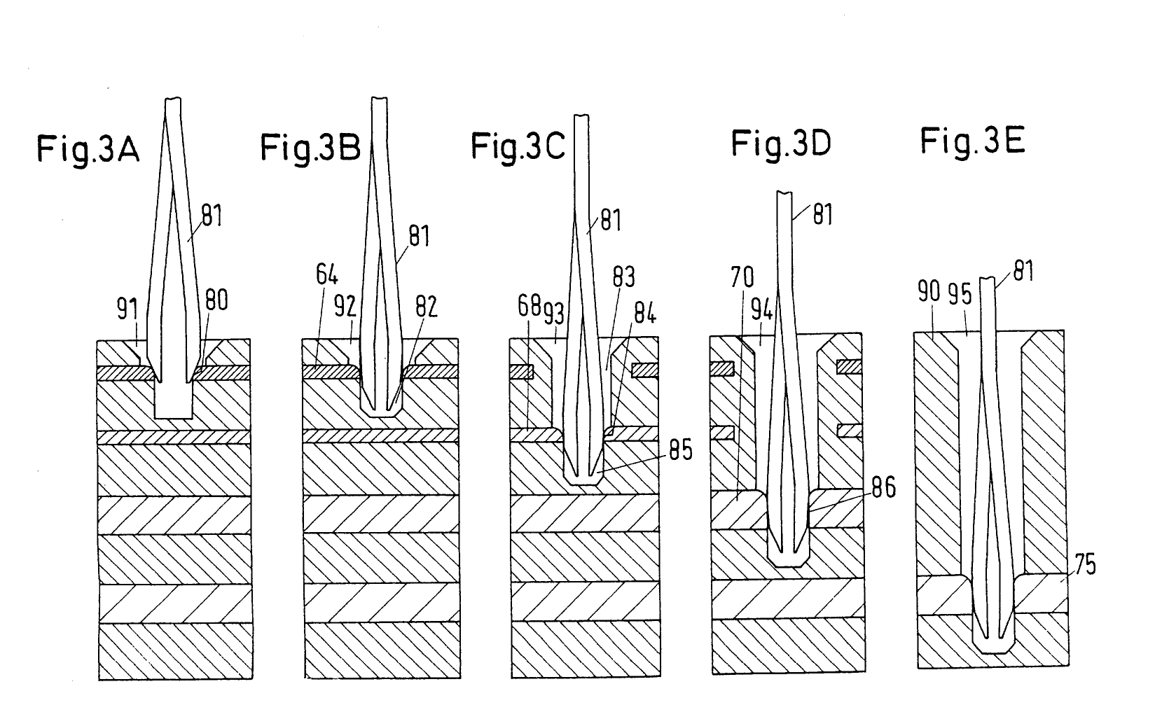

Referring now to the figures of the drawing in detail and first, particularly, to FIG. 1 thereof, there is shown a plan view of a busbar configuration, which can be inserted in a busbar housing, as is illustrated in FIGS. 2 and 3.

A busbar L1 has a connection web or piece 61 that runs at right angles to a direction in which service devices are disposed in a row and on which tongues 62, 63 and 64 are integrally formed at right angles thereto. A length of the connection piece 61 corresponds to a distance between the service devices, and a length of the tongues 62 to 64 corresponds to the length of the row of service devices, seen in the direction of the row.

A busbar L2 is constructed in a similar way. The busbar L2 has a connection web 65, on which a number of tongues 66, 67 and 68, corresponding to the number of phases, are integrally formed. The tongues 66 and 62, 67 and 63, 68 and 64 run parallel to one another and project in the same direction from their connection webs 61, 65.

These two-phase conductors L1, L2 have an associated third phase conductor (busbar) L3, which has a connection web or part 69 on which tongues 70, 71 and 72 are integrally formed. The connection part 69 is located in the vicinity of the ends of the tongues 62, 66; 63, 67; 64, 68, and the tongues 70, 71 and 72 project in the opposite direction to the connection pieces 61 and 65.

The three-phase conductors L1, L2, L3 have an associated neutral conductor N, which has a similar construction, with a connection piece 73 disposed underneath the connection piece of 69, and has tongues 74, 75, 76, 77, 78, 79, 80, 81 which project in the same direction as the tongues 70, 71 and 72. A plate, which is located underneath the individual phase busbars L1-L3 and the neutral conductor N, is also provided, as a protective ground conductor.

FIGS. 3A-3E show cross-sectional views through the busbars, which are embedded in an insulating material 90. As can be seen, the individual busbars L1, L2, L3 are disposed in different planes. By way of example, the busbar L1 is located with its tongue 64 in a first plane, which is to say in the uppermost plane. As can be seen, the busbar L1 or the tongue 64 has openings 80, through which contact springs 81 engage, which will be described in more detail further below. On the extreme left in the drawing in FIG. 3A, the contact spring 81 is currently being inserted into the opening 80; in FIG. 3B, the contact spring 81 has engaged in a blind hole 82 located underneath the tongue 64.

The tongue 68 is located in a second plane underneath the tongue 64. The contact spring element 81 comes into contact with the tongue 68 through an aperture opening 83, with the tongue 68 passing through an opening 84 in the tongue 68 and engaging into a blind hole 85 located underneath. Contact with the tongue 64 is avoided by configuring the aperture opening 83 to be of sufficient dimensions.

A tongue 70 could be provided, by way of example, in the plane located further below, through whose opening 86 the contact spring 81 is passed; in FIG. 3E, the contact spring 81 makes contact with a busbar in a fourth plane, that is to say with the tongue for example of the neutral conductor 75.

FIGS. 3A to 3E show that the individual busbars L1, L2, L3, N are embedded in the insulating material body 90, which has access openings 91, 92, 93, 94 and 95 to the individual tongues 64, 68, 70, 75.

The drawing in FIG. 2 shows the configuration as shown in FIGS. 3A-3E illustrated schematically, but with only three planes of busbars, rather than four planes, located one above the other.

The contact spring 81 in FIG. 2 has the same reference number 81, although its configuration is slightly different, in order to illustrate the similarity with regard to its function.

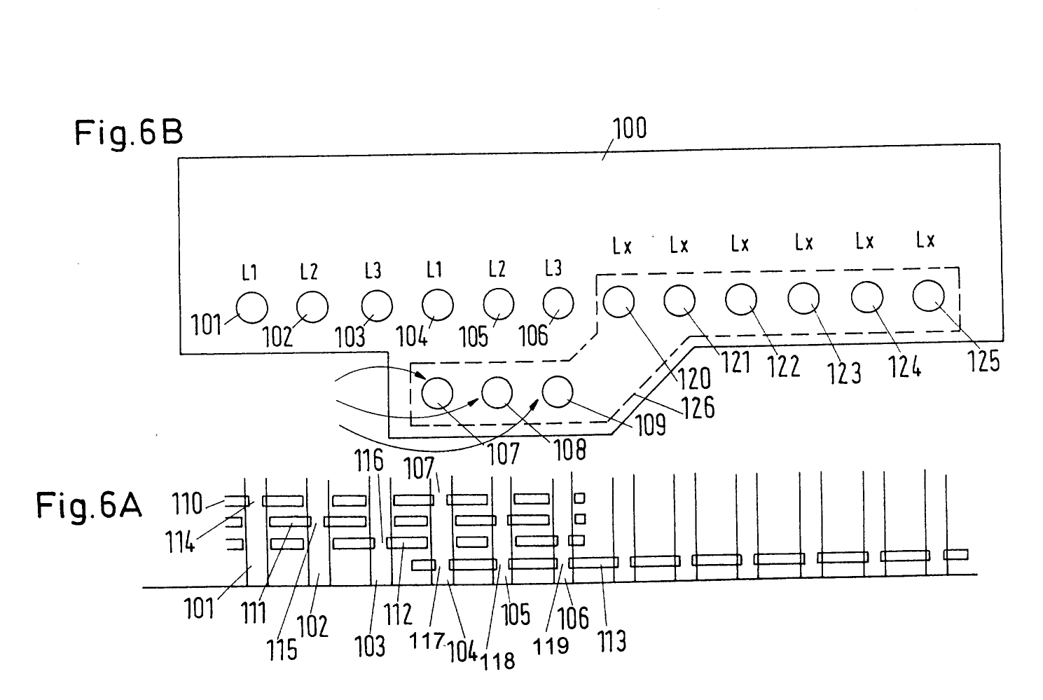

FIG. 2 also shows a contact element 96, which connects the busbars, which are located in plane 1 and plane 3, to one another. FIGS. 6A and 6B show the reason why this is necessary. An insulating material housing 100 which holds the busbars L1-l3 and corresponds to the insulating material housing 90 in FIG. 2 has openings 101, 102, 103, 104, 105 and 106 as well as openings 107, 108 and 109.

FIG. 6A shows a section that corresponds to FIGS. 3A-3E, through the busbar housing 100. A total of four busbar 110, 111, 112 and 113 are provided in this case in different planes. The busbar 110, which is located in a region of the opening 101, has an aperture 114 that is smaller than the diameter of the hole 101. In the opening 102, the busbar 111 has an aperture 115, which is of the same size as the aperture 114, and is thus smaller than the hole 102. In the region of the hole 103, the busbar 112 has an aperture 116, whose internal diameter corresponds to the internal diameter 114 and 115. If a module with contact springs 81, for example contact fingers as shown in FIGS. 3A-3E, is now inserted into the openings 101, 102, 103, then the contact springs 81 make contact first with the busbar 110 and furthermore with the busbar 111 and the busbar 112.

The busbar 113 is located underneath the three busbars 110, 111, 112; as can be seen, the busbar 113 has openings 117, 118 and 119. The openings 117 to 119 have the same diameter as the opening 114, 115 and 116, and are located, so that the phase of the busbar 110 can be connected to the busbar 113 by a contact piece, for example the contact piece 96. For this purpose, the contact piece 96 that connects the busbars 110 and 113 to one another is inserted into the opening 107.

The busbar 111 can make contact with the busbar 113, and the busbar 112 can make contact with the busbar 113, in the same way.

Further the holes, 120, 121, 122, 123, 124 and 125, which thus lie in a line, are provided to the right of the holes 101 to 106 in FIG. 6B. Service devices that are inserted into the holes 120 to 125 can then be connected as required via the busbar 113 to that phase which is provided in the busbar 110, in the busbar 111 or in the busbar 112. FIGS. 6A and 6B show a corresponding connection line 126, represented by a dashed line.

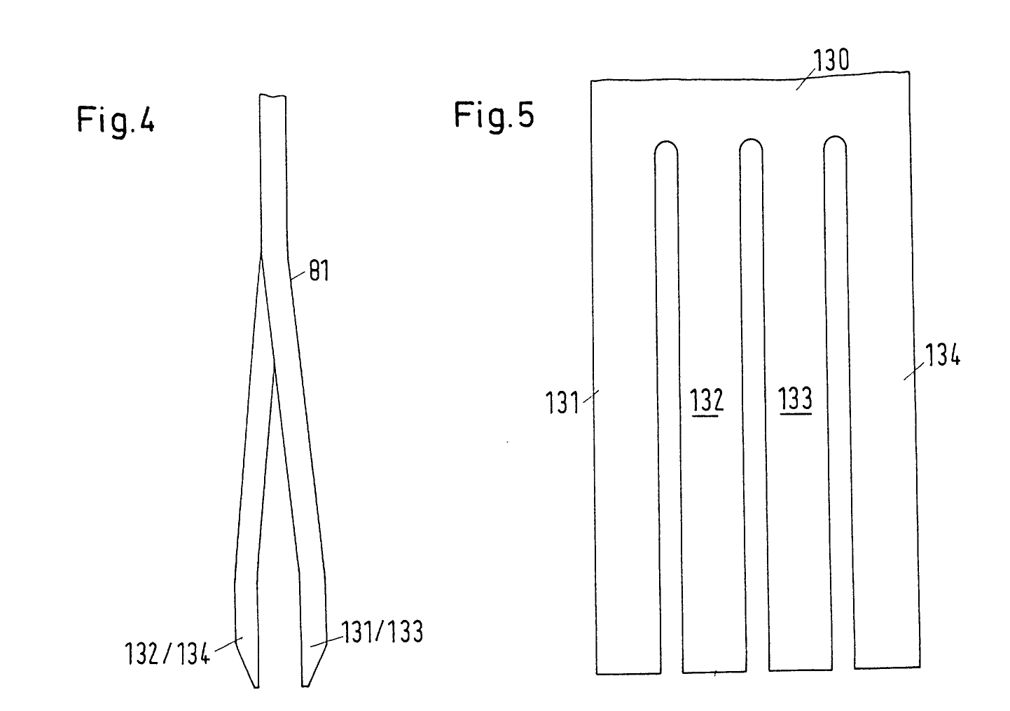

FIGS. 4 and 5 show the contact spring 81. Tongues 131, 132, 133 and 134 are integrally formed in the form of tines on a common contact support 130, and are bent with respect to one another as can be seen in FIG. 4. The tongues 131 and 133 are bent out to the right (see FIG. 4) there, and the tongues 132 and 134 are bent out to the left.

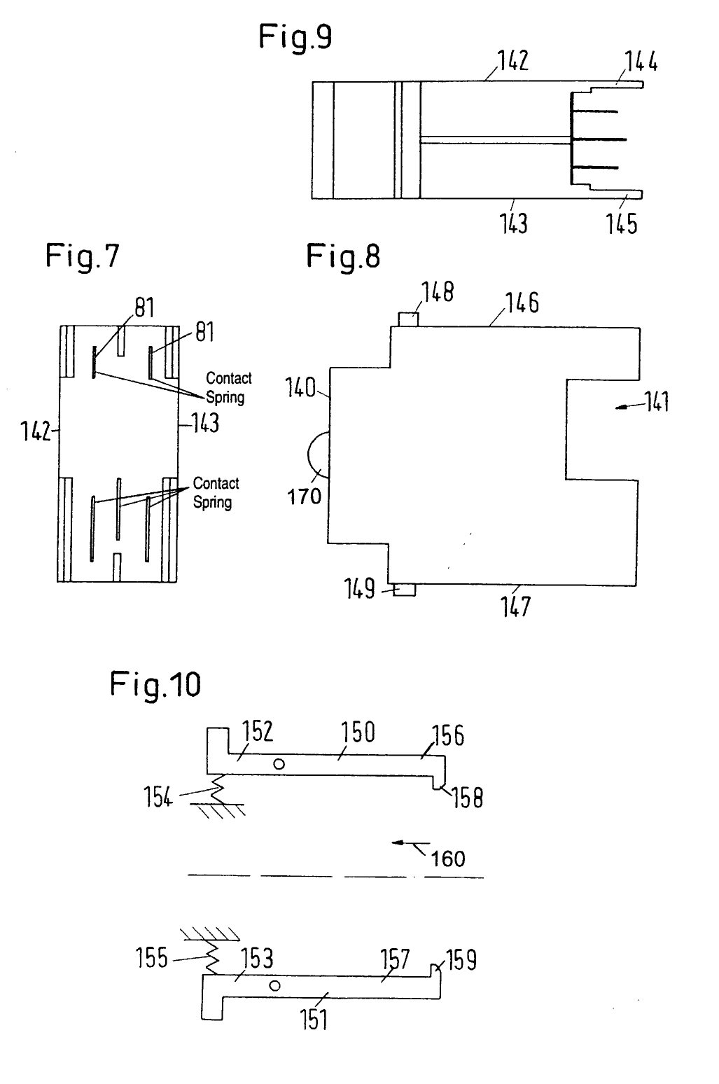

FIGS. 7 to 10 show a refinement of the service device. The service device is configured approximately in a T shape or a cap shape with a front face 140 and a mounting face 141. The front face 140 has a surface with control elements 170. The contact springs 81 on the mounting face point toward one another in an appropriate configuration. Webs 144 and 145 are connected to the broad faces 142 and 143, lie in the same plane as the broad faces 142, 143, and are used to guide the device in the housing for the busbars.

Projecting tabs 148, 149 are integrally formed on the narrow faces 146 and 147, and can be used to fix the service device by the device lock as shown in FIG. 10. The configuration shown in FIG. 10 has two double armed levers 150 and 151 which are mounted such that they can rotate, with springs 154 and 155 acting on the lever arms 152 and 153 which face the mounting face, and the springs 154 and 155 force the arms 152, 153 apart from one another—and the other arms 156 and 157 toward one another. Free ends of arms 156 and 157 have tabs 158 and 159 that point toward one another. During installation, the tabs 158 and 159 engage behind the projecting tabs or strips 148 and 149, with the module being inserted with the mounting face 141 in the direction of the arrow 160 between the two double-armed levers 150 and 151.

We claim:

1. An electrical service distribution board, comprising:
an insulating housing;
a feed conductor;
outgoer conductors leading to individual loads;
busbars connected to said feed conductor and to said outgoer conductors, said busbars of different phases and feeds and said outgoer conductors disposed insulated with respect to one another and from one another in equivalent planes and embedded in said insulating housing;
a plug connection;
electrical service devices selected from the group consisting of fault-current circuit breakers and circuit breakers, and connected by said plug connection to said busbars;
plug elements disposed on said electrical services devices; and
a mounting plate for holding said electrical service devices, said busbars disposed underneath said mounting plate, said mounting plate having openings formed therein into which said plug elements disposed on said electrical service devices can be inserted toward said busbars.

2. The service distribution board according to claim 1, wherein:
said electrical service devices disposed in installation rows;
each of said busbars has one connection section running transversely with respect to a direction in which said electrical service devices are disposed in the installation rows, for each of the phases; and
said busbars have a number of tongues corresponding to a number of the installation rows and disposed in said connection section, said tongues run underneath said electrical service devices and have holding openings formed therein for receiving said plug elements.

3. The service distribution board according to claim 2, wherein one of said busbars is a neutral conductor having said connection section running transversely with respect to the direction in which said electrical service devices are disposed in said installation rows, and to which a number of said tongues corresponds to a number of said installation rows and are disposed in said connection section of said neutral conductor, said tongues of said neutral conductor running underneath said electrical service devices and have said holding openings for receiving said plug elements.

4. The service distribution board according to claim 1, wherein said busbars have tongues for different phases and are disposed one above another and said tongues for the different phases are offset with respect to one another.

5. The service distribution board according to claim 1, wherein each of said busbars have tongues and said tongues of a respective busbar lie in a same plane, and said tongues of at least two of said busbars lie in a further plane.

6. The service distribution board according to claim 5, wherein said tongues of one phase preferably lie in one plane, and said tongues of other phases and of a neutral conductor lie in different planes.

7. The service distribution board according to claim 1, wherein two of said busbars are disposed in different planes for single-phase devices, said two of said busbars are connected by said plug connection, to one phase.

8. The service distribution board according to claim 1, wherein said plug elements have at least one pair of tines formed such that said tines are sprung transversely with respect to an insertion direction.

9. The service distribution board according to claim 1, wherein said plug elements have two tines offset and sprung transversely with respect to an insertion direction.

10. The service distribution board according to claim 1, wherein said busbars and said outgoer conductors are encapsulated in said insulating housing.
